(19) United States
(12) Patent Application Publication
(10) Pub. No.: US 2015/0034598 A1
(43) Pub. Date: Feb. 5, 2015

(54) STRUCTURE FOR PREVENTING ECCENTRICITY OF MOVABLE CONTACT IN VACCUM CIRCUIT BREAKER

(71) Applicant: HYUNDAI HEAVY INDUSTRIES CO., LTD., Ulsan (KR)

(72) Inventor: Hyun-jae Kim, Ulsan (KR)

(21) Appl. No.: 14/126,543

(22) PCT Filed: Dec. 18, 2012
(86) PCT No.: PCT/KR2012/011063

§ 371 Date: Dec. 16, 2013

(30) Foreign Application Priority Data
Apr. 25, 2012 (KR) 10-2012-0043315

(51) Int. Cl. H01H 33/66; H01H 33/666

(52) U.S. Cl. CPC H01H 33/6606; H01H 33/666
USPC 218/140

(57) ABSTRACT

The present invention relates to a vacuum circuit breaker, and more particularly, to a structure for preventing the eccentricity of a movable contact in a vacuum circuit breaker, wherein the concentricity of a fixed contact and the movable contact is maintained by preventing the eccentricity of and maintaining the straightness of the movable contact when the vacuum circuit breaker opens/closes so as to improve sealing performance and to prevent the increase in temperature. The present invention provides the structure for preventing eccentricity of a movable contact in a vacuum circuit breaker, including a housing which comprises an upper terminal installed at an upper portion thereof, a lower terminal installed at a lower portion thereof, and a vacuum interrupter installed therein; a terminal part which comprises a fixed contact and the movable contact disposed in the vacuum interrupter to be contacted with and separated from each other; a rod part including a connecting rod which is connected to the movable contact to move the movable contact in the vacuum interrupter, and passed through the lower terminal to be connected with the movable contact; and a stretchable terminal which is contacted and electrically connected with the lower terminal and the connecting rod, and contacted with the connecting rod to enclose a side surface of the connecting rod.

### TECHNICAL FIELD

The present invention relates to a vacuum circuit breaker, and more particularly, to a structure for preventing eccentricity of a movable contact in a vacuum circuit breaker, in which concentricity between a fixed contact and a movable contact is maintained by preventing eccentricity of the movable contact and maintaining straightness thereof when the vacuum circuit breaker is opened/closed, thereby improving breaking performance and controlling increase in temperature.

### BACKGROUND ART

A circuit breaker is an electrical protecting apparatus for protecting load appliances and lines from a fault current due to short circuit, grounding, etc. that may occur on an electric circuit.

According to used arc extinguishing medium, the circuit breaker can be classified into an oil circuit breaker using oil as an arc extinguishing, a gas circuit breaker using inert gas of SF6, an air blast circuit breaker using air, a magnetic blast circuit breaker using magnetism, and a vacuum circuit breaker using dielectric strength in vacuum.

Among them, the vacuum circuit breaker is a circuit and appliance protecting apparatus in which arc generated when switching a normal load or breaking a fault current is extinguished in a vacuum interrupter in order to rapidly separate a circuit.

For example, a conventional vacuum circuit breaker includes a housing, a terminal part, a rod part and a stretchable terminal. Upper and lower terminals are formed at upper and lower portions of the housing, and a fixed contact connected to the upper terminal and a movable contact connected to the lower terminal are configured to be contacted with and separated from each other in a vacuum interrupter disposed in the housing.

Meanwhile, the rod part is connected to the movable contact so as to lift up and down the movable contact. In order to electrically connect the lower terminal with the rod part, the stretchable terminal is formed into a single metal piece of which one end is connected to the lower terminal, and the other end is connected to the rod part, and pressure-welded at two points thereof.

In the conventional vacuum circuit breaker as described above, there is a problem that, when the movable contact moves up and down, the movable contact is inclined to one side, i.e., eccentricity of the movable contact is occurred.

Further, since the stretchable terminal connects the movable contact and the rod part in only one direction, straightness of the movable contact is not maintained due to an eccentric load generated when the movable contact moves.

Therefore, since eccentricity of the movable contact is occurred and the straightness thereof is not maintained, concentricity between the fixed contact and the movable contact is not maintained, and breaking performance is deteriorated, and also temperature is raised abnormally when a rated current is applied.

### DISCLOSURE

### Technical Problem

The present invention is directed to providing a structure for preventing eccentricity of a movable contact in a vacuum circuit breaker, in which concentricity between a fixed contact and a movable contact is maintained by preventing eccentricity of the movable contact and maintaining straightness thereof when the vacuum circuit breaker is opened/closed, thereby improving breaking performance and preventing increase in temperature

### Technical Solution

One aspect of the present invention provides a structure for preventing eccentricity of a movable contact in a vacuum circuit breaker, including a housing which comprises an upper terminal installed at an upper portion thereof, a lower terminal installed at a lower portion thereof, and a vacuum interrupter installed therein; a terminal part which comprises a fixed contact and the movable contact disposed in the vacuum interrupter to be contacted with and separated from each other; a rod part including a connecting rod which is connected to the movable contact to move the movable contact in the vacuum interrupter, and passed through the lower terminal to be connected with the movable contact; and a stretchable terminal which is contacted and electrically connected with the lower terminal and the connecting rod, and contacted with the connecting rod to enclose a side surface of the connecting rod.

The stretchable terminal may include a flat coupling portion having a through-hole through which the connecting rod is passed; first and second supporting portions which are respectively vertically extended from both edges of the coupling portion, and first and second bonding portions which are respectively vertically extended from the first and second supporting portions to an outside.

The structure may further include a guide bush interposed between the lower terminal and the connecting rod.

The connecting rod may be passed through and connected with the bonding portion, and each of the first and second bonding portions may be connected and fixed to the lower terminal to electrically connect the lower terminal and the connecting rod.

### Advantageous Effects

Therefore, since the stretchable terminal is pressure-welded at three points, a contacting surface area is increased, and generated heat is rapidly diffused due to the increased contacting surface area, and thus temperature rise is restricted.

Also, since the connecting rod is passed through a through-hole formed in a coupling portion of the stretchable terminal, and thus an outer surface of the connecting rod is enclosed by the coupling portion, it is possible to prevent eccentricity and eccentric load which are generated when the connecting rod moves up and down.

Therefore, since the eccentricity and eccentric load of the connecting rod are prevented, it is possible to maintain straightness of the connecting rod and the movable contact which is moved while being connected to the connecting rod, and thus it is possible to maintain concentricity between the fixed contact and the movable contact, thereby improving breaking performance and restraining abnormal temperature rise generated by the fixed contact and the movable contact which are contacted eccentrically with each other.

### DESCRIPTION OF DRAWINGS

FIG. 1 is a side cross-sectional view illustrating a structure for preventing eccentricity of a movable contact in a vacuum circuit breaker according to an embodiment of the present invention.

FIG. 2 is a front cross-sectional view illustrating the structure for preventing eccentricity of the movable contact in the vacuum circuit breaker according to the embodiment of the present invention.

FIG. 3 is a perspective view illustrating a stretchable terminal of the structure for preventing eccentricity of the movable contact in the vacuum circuit breaker according to the embodiment of the present invention.

### MODES OF THE INVENTION

Hereinafter, exemplary embodiments of the present invention will be described in detail. However, the present invention is not limited to the exemplary embodiments disclosed below, but can be implemented in various forms. The following exemplary embodiments are described in order to enable those of ordinary skill in the art to embody and practice the invention.

It will be further understood that terms, such as those defined in commonly used dictionaries, should be interpreted as having a meaning that is consistent with their meaning in the context of the relevant art and will not be interpreted in an idealized or overly formal sense unless expressly so defined here.

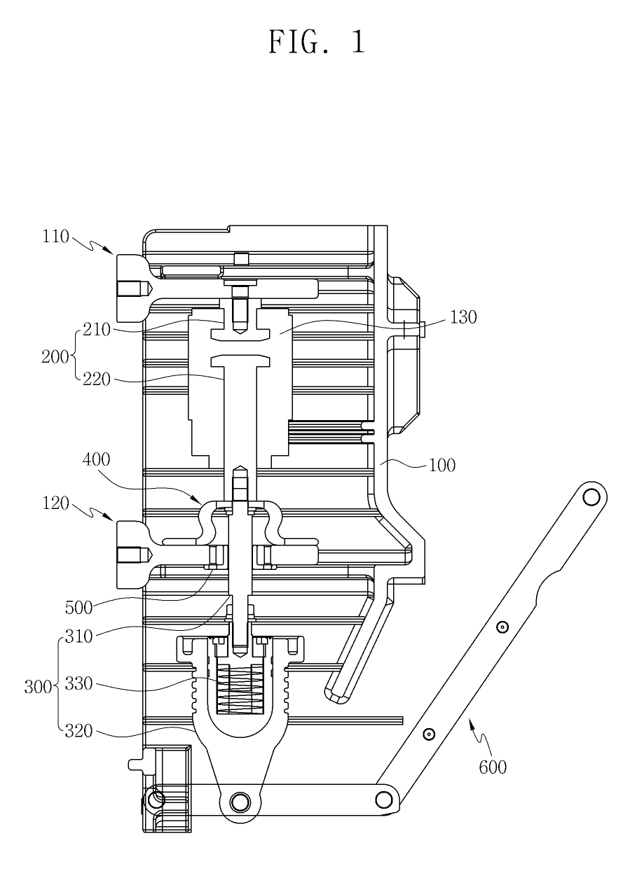

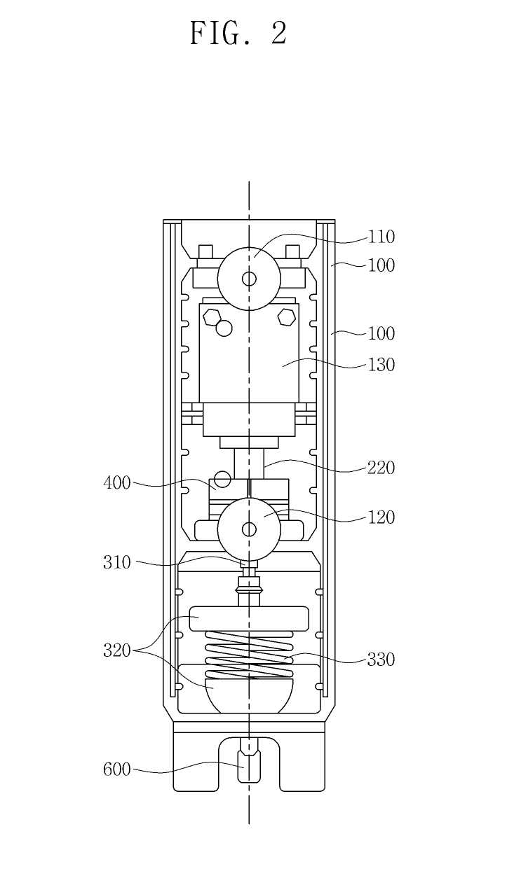

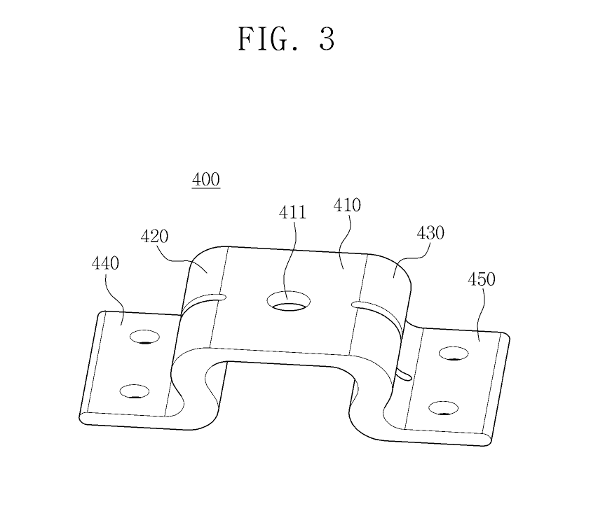

FIG. 1 is a side cross-sectional view illustrating a structure for preventing eccentricity of a movable contact in a vacuum circuit breaker according to an embodiment of the present invention, FIG. 2 is a front cross-sectional view illustrating the structure for preventing eccentricity of the movable contact in the vacuum circuit breaker according to the embodiment of the present invention, and FIG. 3 is a perspective view illustrating a stretchable terminal of the structure for preventing eccentricity of the movable contact in the vacuum circuit breaker according to the embodiment of the present invention.

Hereinafter, a structure for preventing eccentricity of a movable contact in a vacuum circuit breaker according to an embodiment of the present invention will be described with reference to FIGS. 1 to 3.

The for preventing eccentricity of the movable contact in the vacuum circuit breaker according to an embodiment of the present invention includes a housing 100, a terminal part 200, a rod part 300, a stretchable terminal 400 and a guide bush 500.

Here, the housing 100 includes an upper terminal 110 installed at an upper portion thereof, a lower terminal 120 installed at a lower portion thereof, and a vacuum interrupter 130 installed therein.

The upper terminal 110 functions as an input terminal which is electrically connected with a power line of a power source so that a current supplied from the power source is flowed in the vacuum circuit breaker, and the lower terminal 120 functions as an output terminal which is electrically connected with a power line of a load so that the current flowed in the vacuum circuit breaker is flowed to the load.

Meanwhile, the vacuum interrupter 130 is a vacuous area in which a fixed contact 210 and a movable contact 220 of the terminal part 200 are located to be contacted with and separated from each other, and an arc generated when the fixed contact 210 and movable contact 220 are separated from each other is extinguished.

The terminal part 200 includes the fixed contact 210 and the movable contact 220 which are contacted with and separated from each other in the vacuum interrupter 130. At this time, the fixed contact 210 is electrically connected with the upper terminal 110, and the movable contact 220 is electrically connected with the lower terminal 120.

At this time, the fixed contact 210 is extended downwardly from the upper terminal 110, and passed through an upper portion of the vacuum interrupter 130 so as to be located at the upper portion of the vacuum interrupter 130.

Meanwhile, the movable contact 220 may be passed through a lower portion of the vacuum interrupter 130 so as to be located at the lower portion of the vacuum interrupter 130. At this time, the movable contact 220 is disposed to be moved up and down by the rod part 300.

At this time, the fixed contact 210 and movable contact 220 are disposed to maintain concentricity therebetween.

The rod part 300 is a member which is connected with the movable contact 220 in order to move the movable contact 220 in the vacuum interrupter 130. The rod part 300 may include a connecting rod 310 which is connected with the movable contact 220 and an insulating rod 320 which is connected with the connecting rod 310 and operated by a driving device 600 in order to move the connecting rod 310.

At this time, the connecting rod 310 is passed through the lower terminal 120 and connected with the movable contact 220.

Meanwhile, an upper end of the connecting rod 310 is connected with a lower end of the movable contact 220, and the insulating rod 320 is connected with a lower end of the connecting rod 310, and the insulating rod 320 is moved up and down by the driving device 600.

Therefore, the insulating rod 320 is moved up and down by the driving device 600, and thus the connecting rod 310 connected to an upper portion of the insulating rod 320, and the movable contact 220 connected with the upper end of the connecting rod 310 is also moved up and down.

At this time, the driving device 600 which is connected to the insulating rod 320 in order to operate the insulating rod 320 may be, for example, a lever, and a bellows 330 may be further installed at a position of the insulating rod 320, which is connected with the connecting rod 310.

The stretchable terminal 400 is located at an upper side of the lower terminal 120, i.e., between the lower terminal 120 and the movable contact 220, and connected with each of the lower terminal 120 and the connecting rod 310 so that the lower terminal 120 and connecting rod 310 are electrically connected with each other. The stretchable terminal 400 is formed to be stretchable and thus lifted up and down when the connecting rod 310 is lifted up and down.

At this time, the stretchable terminal 400 is contacted with the connecting rod 310 while enclosing a side surface of the connecting rod 310.

The stretchable terminal 400 may have wrinkles in order to be facilely stretched, and may be formed by stacking multiple copper plates having a thin thickness, for example a thickness of 0.05 to 0.1 mm.

Meanwhile, as shown in FIG. 3, the stretchable terminal 400 includes a flat coupling portion 410 having a through-hole 411 through which the connecting rod 310 is passed, first and second supporting portions 420 and 430 which are respectively extended vertically from both edges of the coupling portion 410, and first and second bonding portions 440 and 450 which are respectively extended vertically from the first and second supporting portions 420 and 430 to an outside.

At this time, since the connecting rod 310 is passed through the coupling portion 410 and contacted with each other, and each of the first and second bonding portions 440 and 450 is connected and fixed to the lower terminal 120, the lower terminal 120 and connecting rod 310 are electrically connected with each other by the stretchable terminal 400.

Therefore, the stretchable terminal 400 electrically connects the lower terminal 120 and the connecting rod 310 through three contacting points, i.e., a contacting point between the connecting rod 310 and the coupling portion 410, a contacting point between the lower terminal 120 and the first bonding portion 440 and a contacting point between the lower terminal 120 and the second bonding portion 450.

The guide bush 500 is interposed between the lower terminal 120 and the connecting rod 310 in order to maintain straightness of the connecting rod 310. The guide bush 500 may be formed into a circular plate having a hole at a center thereof

Therefore, in the conventional art, the stretchable terminal is pressure-welded at two points, but according to the embodiment, since the stretchable terminal 400 is pressure-welded at three points, a contacting surface area is increased, and thus generated heat may be diffused rapidly by the increased contacting surface area, thereby restraining temperature rise.

Further, since the connecting rod 310 is passed through the through-hole 411 formed in the coupling portion 410 of the stretchable terminal 400 so that a side surface of the connecting rod 310 is enclosed by the coupling portion 410, it is possible to prevent eccentricity and eccentric load occurred when the connecting rod 310 is moved up and down.

Therefore, since the eccentricity and eccentric load of the connecting rod 310 are prevented, it is possible to maintain straightness of the connecting rod 310 and movable contact 220 which is connected to the connecting rod 310 to be moved, and thus concentricity between the fixed contact 210 and the movable contact 220 can be maintained, whereby breaking performance can be maintained, and temperature rise generated by the fixed contact 210 and the movable contact 220 which are contacted in an eccentric state.

Until now, the technical spirit of the structure for preventing eccentricity of the movable contact in the vacuum circuit breaker according to the present invention is described with reference to the drawings, but the present invention is not limited to this. While the present invention has been described in detail, it should be understood that various changes, substitutions and alterations can be made hereto without departing from the spirit and scope of the invention as defined by the appended claims.

### INDUSTRIAL APPLICABILITY

The present invention can be efficiently applied to a structure for preventing eccentricity of a movable contact in a vacuum circuit breaker, in which concentricity between a fixed contact and a movable contact is maintained by preventing eccentricity of the movable contact and maintaining straightness thereof when the vacuum circuit breaker is opened/closed, thereby improving breaking performance and controlling increase in temperature.

1. A structure for preventing eccentricity of a movable contact in a vacuum circuit breaker, comprising:
a housing which comprises an upper terminal installed at an upper portion thereof, a lower terminal installed at a lower portion thereof, and a vacuum interrupter installed therein;
a terminal part which comprises a fixed contact and the movable contact disposed in the vacuum interrupter to be contacted with and separated from each other;
a rod part comprising a connecting rod which is connected to the movable contact to move the movable contact in the vacuum interrupter, and passed through the lower terminal to be connected with the movable contact; and
a stretchable terminal which is contacted and electrically connected with the lower terminal and the connecting rod, and contacted with the connecting rod to enclose a side surface of the connecting rod.

2. The structure of claim 1, wherein the stretchable terminal comprises,
a flat coupling portion having a through-hole through which the connecting rod is passed;
first and second supporting portions which are respectively vertically extended from both edges of the coupling portion, and
first and second bonding portions which are respectively vertically extended from the first and second supporting portions to an outside.

3. The structure of claim 1, further comprising a guide bush interposed between the lower terminal and the connecting rod.

4. The structure of claim 2, wherein the connecting rod is passed through and connected with the bonding portion, and each of the first and second bonding portions is connected and fixed to the lower terminal to electrically connect the lower terminal and the connecting rod.
